(19) United States
(12) Patent Application Publication
(10) Pub. No.: US 2023/0306490 A1
(43) Pub. Date: Sep. 28, 2023

(54) SYSTEMS AND METHODS FOR IDENTIFYING TOP ALTERNATIVE PRODUCTS BASED ON DETERMINISTIC OR INFERENTIAL APPROACH

(71) Applicant: COUPANG CORP., Seoul (KR)

(72) Inventors: Nishant Agrawal, Sunnyvale, CA (US); Chetan Rao, Fremont, CA (US); Ehsan Khaliki, Palo Alto, CA (US)

(73) Assignee: COUPANG CORP., Seoul (KR)

(21) Appl. No.: 17/704,943

(22) Filed: Mar. 25, 2022

(51) Int. Cl. G06Q 30/06

(52) U.S. Cl. CPC G06Q 30/0631

(57) ABSTRACT

Disclosed embodiments provide systems and methods for identifying a target product and generating alternative product recommendations based on a user query. A computer-implemented system may be configured to perform operations comprising using machine learning to determine a plurality of attributes and at least one pattern associated with a user's product model number search query. The operations may further comprise determining at least one queried product of interest by the user and at least one product category based on an experimental data set. The operations may further comprise determining a target product based on the queried product of interest. The operations may further comprise determining a plurality of key features associated with the queried product based on experimental data, and determining at least one top alternative product. The operations may further comprise transmitting the target product and the top alternative product for display on an external device to the user.

### TECHNICAL FIELD

The present disclosure generally relates to computerized systems and methods for identifying top alternative products based on a user query and key attributes. In particular, embodiments of the present disclosure relate to inventive and unconventional systems for analyzing the intended search query of a user to determine at least one product being searched by the user, identifying any matching product based on the user query, and identifying at least one top alternative product based on the user query using a deterministic rule-based method, an inferential key-attribute-based method, or any combination of the two.

### BACKGROUND

Product queries in current e-commerce systems often do not have the robust capability for analyzing product model numbers beyond a simple string search. For instance, if a user wishes to search for a specific product on an e-commerce website solely based on its product model number (e.g. “RF85A92W1APPW”), the system which relies on string-matching must have that particular model number in its database or memory in order to process the user request and return any relevant product search results. However, if that exact model number does not exist in the system's database or memory due to a number of factors (e.g. if the model number is proprietary or exclusive to another vendor), the system will be unable to understand or analyze the query, and subsequently no product results will be identified or presented to the user. This lack of robustness creates a hindrance to users who wish to accurately pinpoint their specific product of interest based on product model number, as instead, they would be forced to guess alternative search terms or criteria to be entered into the system in order locate the product. Ultimately, this limitation could frustrate the user experience and lead to loss of customers and sales.

Product and alternatives identification in the prior art consists of generating a list of product search results based purely on matching of the user's raw text input. This method of simplified string-matching often fails to identify the user's specific product of interest if the user input consists of only an unidentifiable product model number which is not contained in the system database. Since these systems fail to recognize the original product of interest being queried by the user, they are further incapable of generating any alternative product recommendations based on the initial product. This prevents the specific product sought by the user, or any relevant alternative products to be presented to the user, and unnecessarily burdens the user purchase experience.

Therefore, there is a need for improved methods and systems for robustly identifying the specific product being queried by a user based on its product model number by using machine learning techniques to extract relevant attributes from the product query. At the same time, if no exact match exists based on the product of interest, the methods or systems would automatically identify the likely product categories associated with the user's product of interest, and generate relevant alternative product search results by identifying key features within the product categories utilizing background experimental data.

### SUMMARY

One aspect of the present disclosure is directed to a system for identifying a target product and generating alternative product recommendations based on a user query. The computer-implemented system may include one or more memory storing instructions. The computer-implemented system may also include one or more processors configured to execute the instructions to perform operations. The operations may comprise retrieving a user product search query, a data set, and a set of experimental data from one or more data structures. The operations may further comprise determining, using at least one machine-learning algorithm, a plurality of attributes associated with the product search query, and at least one pattern associated with the plurality of attributes. The operations may further comprise determining at least one queried product of interest by the user and at least one product category associated with the product search query based on the plurality of attributes and the at least one pattern, and the data set. The operations may further comprise determining a target product based on the queried product of interest. The operations may further comprise determining a plurality of key features associated with the queried product based on experimental data, and determining at least one top alternative product. The operations may further comprise transmitting the target product and the top alternative product for display on an external device to the user.

Yet another aspect of the present disclosure is directed to a method for identifying a target product and generating alternative product recommendations based on a user query. The computer-implemented method may comprise retrieving a user product search query, a data set, and a set of experimental data from one or more data structures. The method may further comprise determining, using at least one machine-learning algorithm, a plurality of attributes associated with the product search query, and at least one pattern associated with the plurality of attributes. The method may further comprise determining at least one queried product of interest by the user and at least one product category associated with the product search query based on the plurality of attributes and the at least one pattern, and the data set. The method may further comprise determining a target product based on the queried product of interest. The method may further comprise determining a plurality of key features associated with the queried product based on experimental data, and determining at least one top-alternative product.

Yet another aspect of the present disclosure is directed to a system for identifying a target product and generating alternative product recommendations based on a user query. The computer-implemented system may include one or more memory storing instructions. The computer-implemented system may also include one or more processors configured to execute the instructions to perform operations. The operations may comprise retrieving a user product search query comprising at least an alphanumeric product model number, a text string, or any combination thereof, a data set comprising at least a catalogue of product model numbers collected over a predefined time frame, and a set of experimental data comprising at least aggregated customer data from all customers or a subset of all customers, from one or more data structures. The operations may further comprise determining, using at least one machine-learning algorithm, a plurality of attributes associated with the product search query comprising at least a product model number, a product name, or product description, and at least one pattern associated with the plurality of attributes. The operations may further comprise determining at least one queried product of interest by the user and at least one product category associated with the product search query based on the plurality of attributes and the at least one pattern, and the data set. The operations may further comprise determining a target product based on the queried product of interest. The operations may further comprise determining a plurality of key features associated with the queried product based on the experimental data and mined data from at least one external data source, and determining at least one top-alternative product. The operations may further comprise transmitting the target product and the top alternative product for display on an external device to the user.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a flowchart illustrating an exemplary process for identifying a target product matching the user's queried product, and generating top alternative product search results, consistent with the disclosed embodiments.

FIG. 4 is a diagrammatic illustration of an exemplary system for identifying target products matching the user's queried product based on product model number and generating top alternative product search results.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for selecting and presenting products to users based on past purchases.

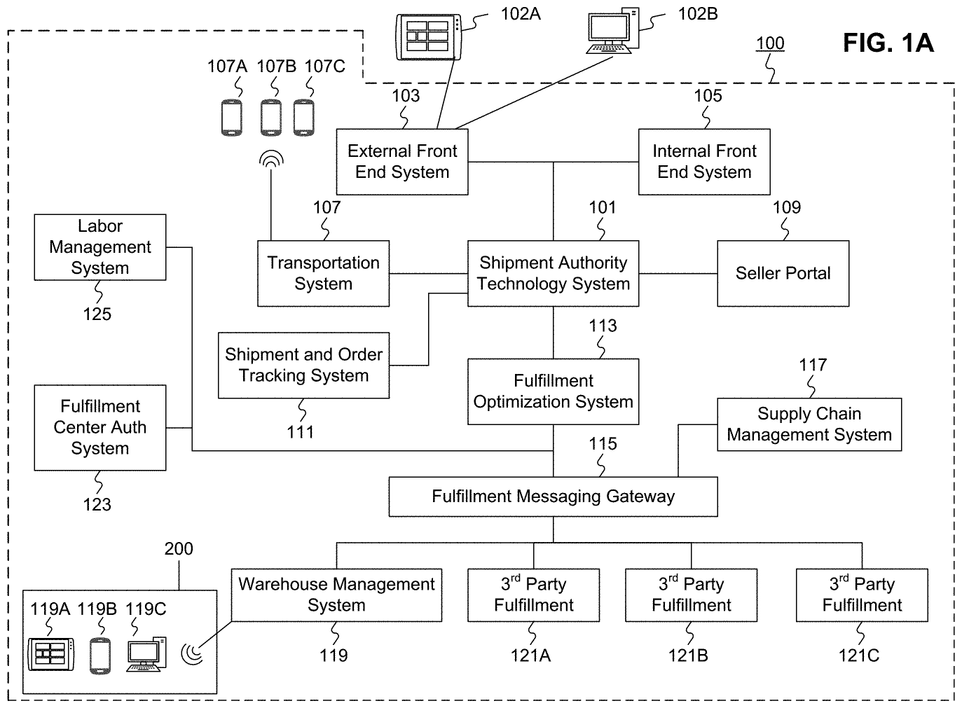

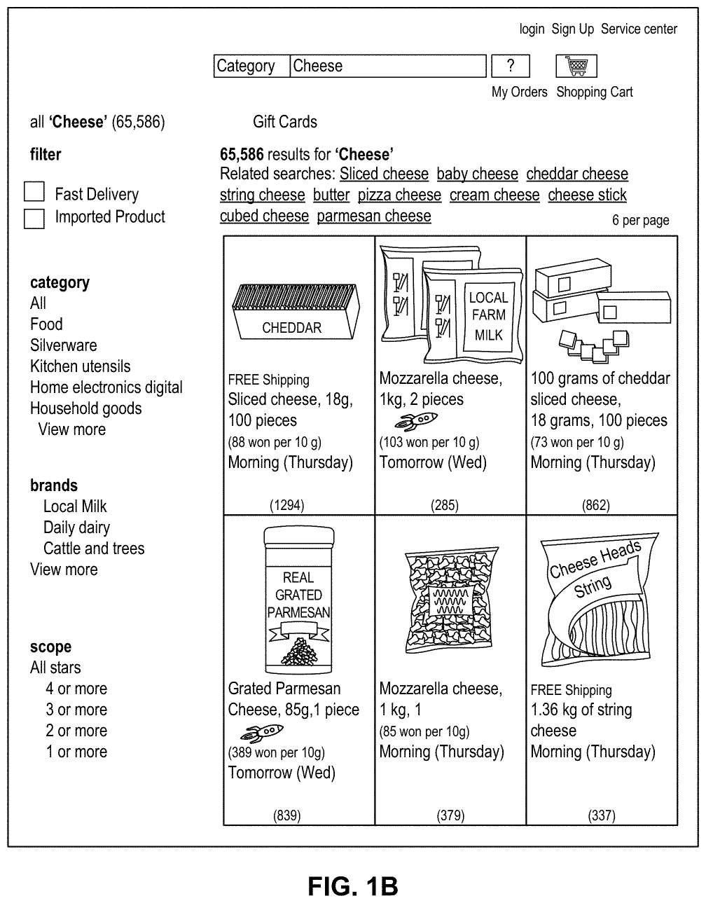

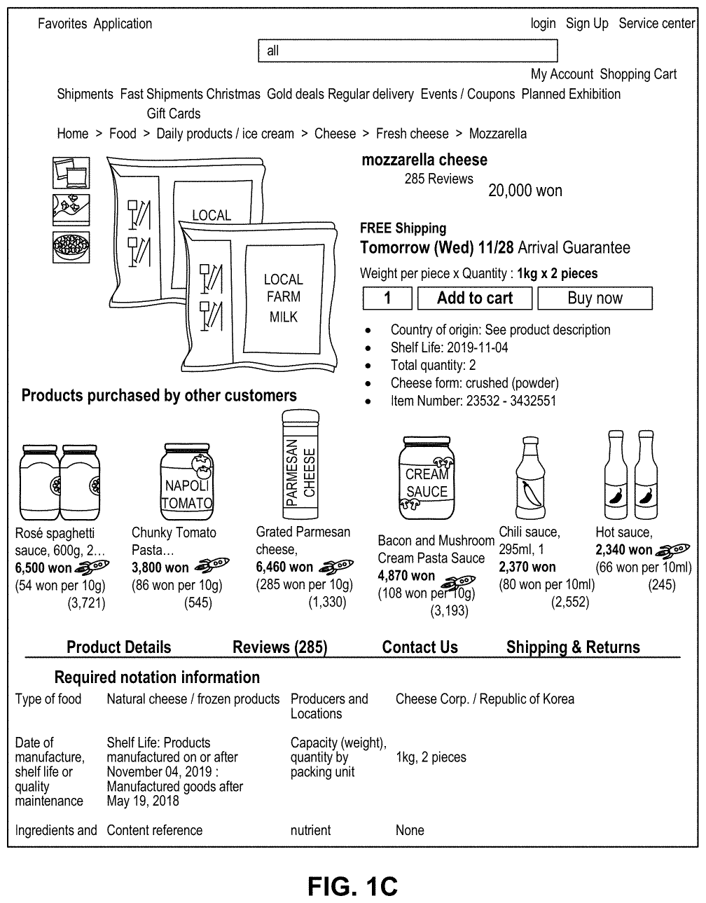

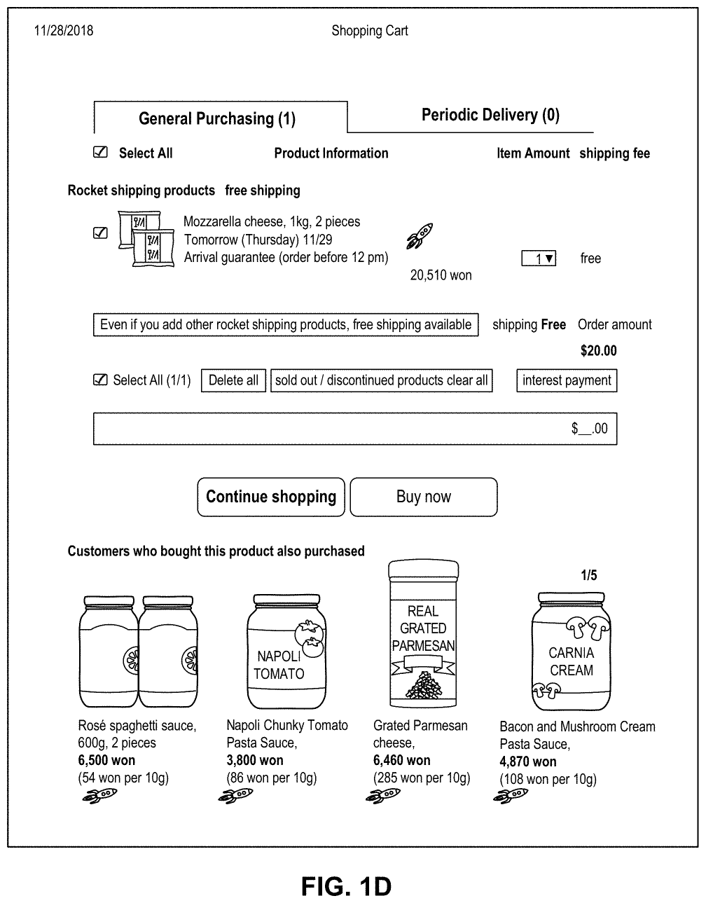

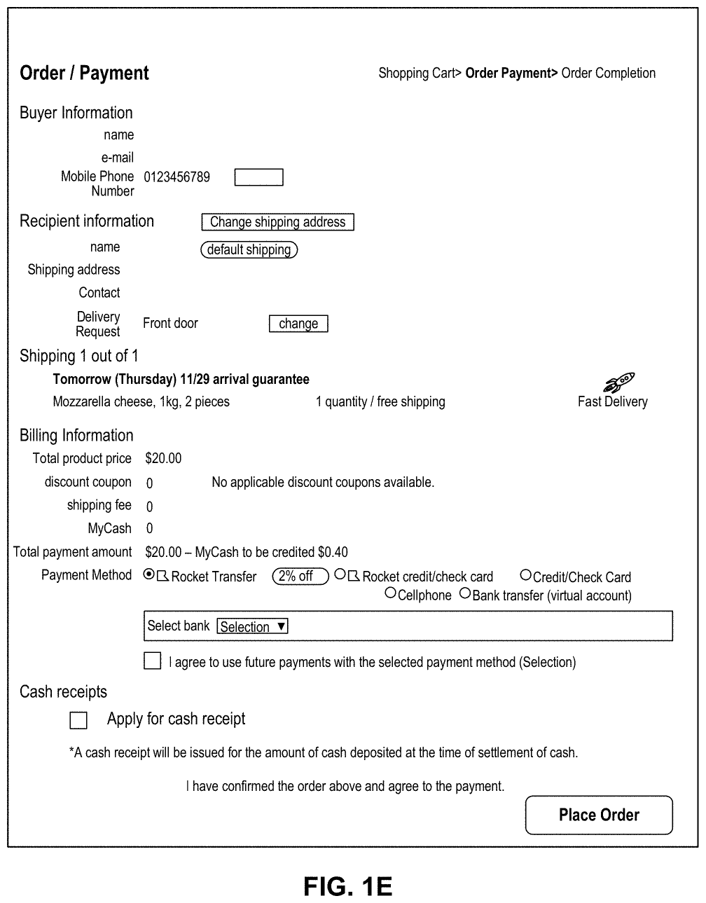

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3rd party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

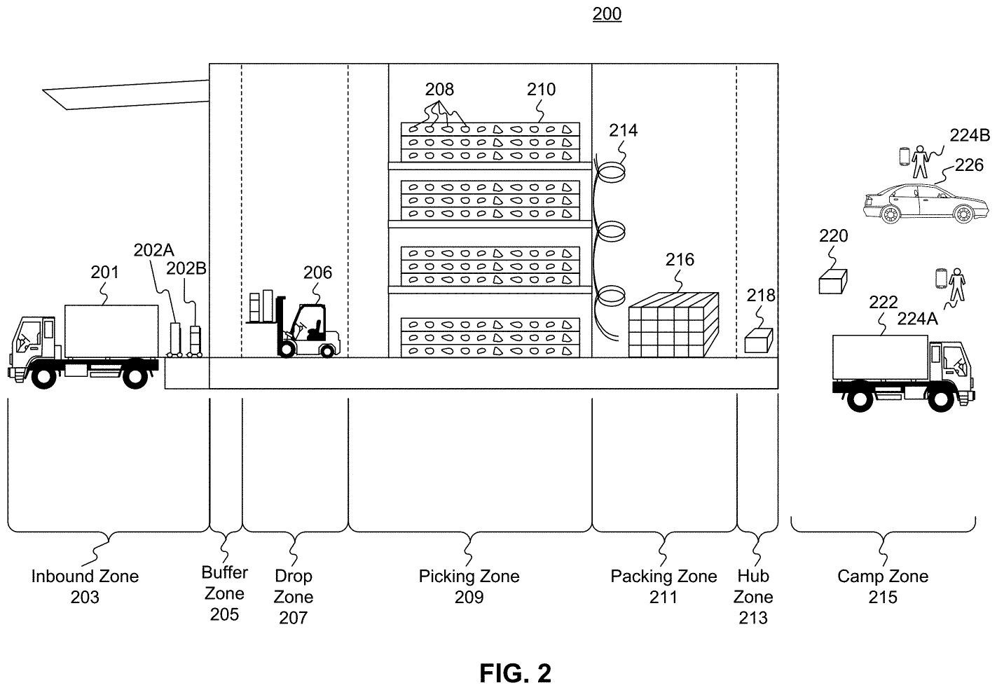

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1198.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

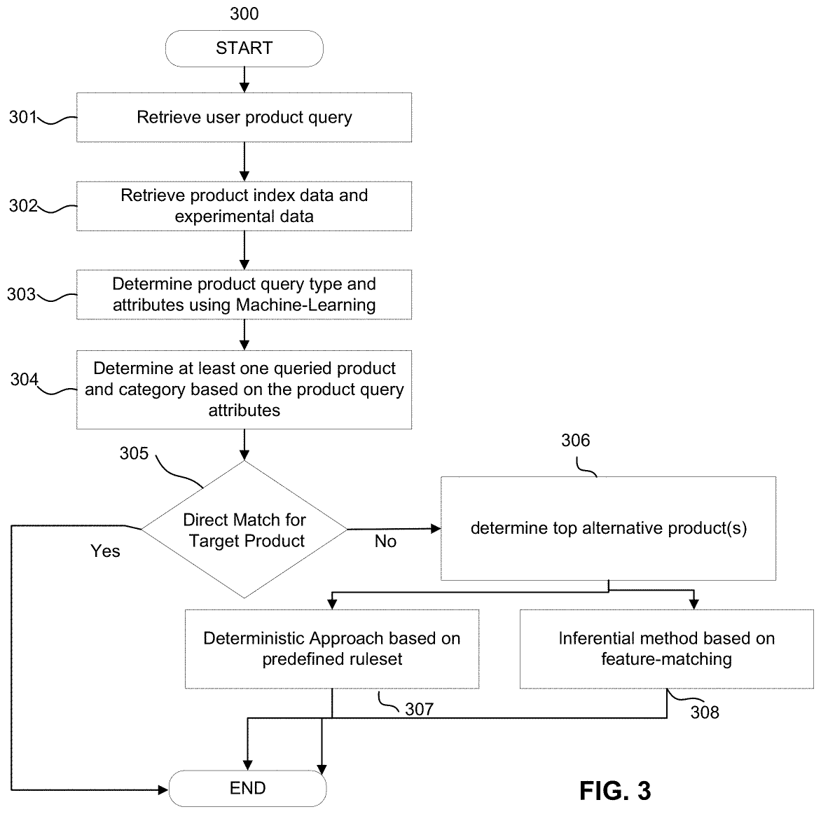

FIG. 3 illustrates an outline of the main process 300 for identifying a target product matching a user's queried product, and generating top alternative product search results using, for example, a deterministic approach, an inferential approach, or a combination approach, consistent with the disclosed embodiments.

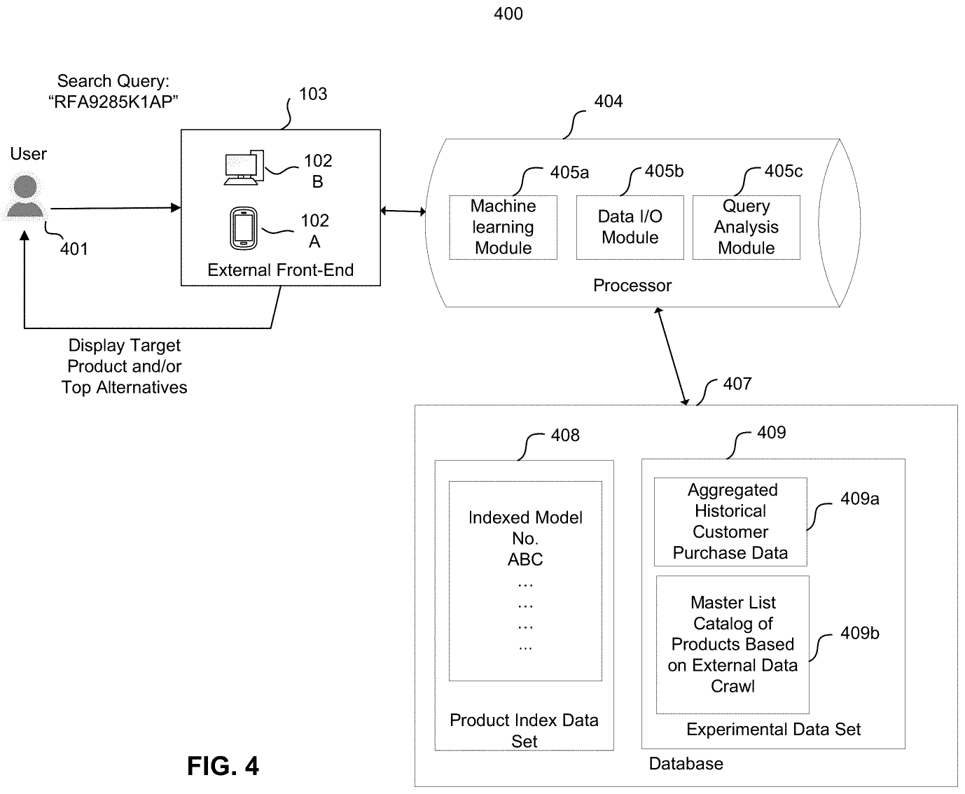

Process 300 begins at step 301 when a user inputs a product model number in order to search for a product of interest into an external front end system 103 associated with a front end device (e.g., mobile device 102A or computer 102B). One or more processors (e.g., processor 404 in FIG. 4) retrieves the user query associated with a product search from the external front end system 103 associated with the front end device (e.g. mobile device 102A or computer 102B. In some embodiments, the user query may be from a web page where a user inputs information into a form, e.g. as in FIG. 1B, or an upload where customer data is uploaded to store to the database.

In some embodiments, user query data can include but is not limited to data related to the product which the user intends to purchase. The user query data format can be but is not limited to character strings, binary strings, numerical data, user-defined SQL Server data types, other data, or any combination thereof. For example, a user query may consists of only product numbers (e.g. “MX-1000”), a mixture of a model number and text string (e.g. “Sony MX-1000”), or only a text string not containing a product model number but nonetheless references a specific product (e.g. “Apple iPhone 13 Pro Max”). In some embodiments, the steps of FIG. 3 may be operated by external front end system 103, while in other embodiments the steps in FIG. 3 may be operated by one or more other devices in network 100.

Process 300 then proceeds to step 302. In step 302, one or more processors (e.g. processor 404) retrieves at least one set of product index data associated from at least one data structure stored in one or more databases (e.g. data structure/database 407 as in FIG. 4). The product index data set can include but is not limited to all the product model numbers of a product category within a specific geographical region (e.g. Korea). In some embodiments, the product index data set comprises product data collected from internal data sources within an e-commerce company. The product index data set may also comprise but is not limited to product information which the processor(s) extract from external data sources (e.g. a competitor product website) using data crawling and data mining. In some embodiments, the product index data set is updated regularly based on a predefined time periodicity. The product index data set can be stored in linear data structures or databases (e.g. 407 in FIG. 4) including but not limited to tables, arrays, linked lists, or non-linear data structures including but not limited to graph data structures or tree data structures. The type of database can comprise of but is not limited to MySQL databases or NoSQL databases such as Cassandra.

Also in step 302, the one or more processors (e.g. processor 404) retrieve at least one set of experimental data from at least one data structure. In some embodiments, the source of the set of experimental data can consist of but is not limited to aggregated data across all users or a subset of all users associated with historical product purchases. In some embodiments, the experimental data can include product purchase data associated with the product queries inputted by all or a subset of all users. For example, the experimental data may contain data for product X purchased (e.g. “Samsung MX-1900 16-inch ultraportable laptop”) and the set of associated query input by all users to find that particular product (e.g. user A entered “Samsung 1900 laptop” as the product query to purchase product X; user B entered “Samsung 16-inch laptop” to purchase product X, etc). In some embodiments, the experimental data can include but is not limited to a hierarchically-structured set of product categories, ranging from broad categories (e.g. “Household”, or “Dental”) to more granular categories (e.g. “Toothpaste”, “Whitening Toothpaste”). In some embodiments, the experimental data can include but is not limited to a master list catalog of products at least partially based on data mined from external data sources (e.g. a competitor product website or a publicly-available competitor product catalog).

Process 300 then proceeds to step 303. In step 303, the one or more processors (e.g. processor 404) may perform standardization or normalization of the user query using natural language processing techniques. The natural language processing techniques may comprise but is not limited to text tokenization, stemming, and lemmatization. For example, the processor may normalize a user query consisting of a non-standardized entry of a product model number “#RF-A-9285K1 AP!#” into the standardized form of “RFA9285K1AP.” In another example, the processor may normalize a user query consists of “tooth-paste” or “tooth paste” into the standardized form of “toothpaste” in order to facilitate database search.

In step 303, the one or more processors analyze the normalized user query and may determine the type of user query based on the analysis. In some embodiments, the processor(s) may identify the type of search within the user query as a search for a single product (i.e. a “spearfishing query”). In some embodiments, the processor(s) may identify the search as a search for multiple products. In some embodiments, the processor(s) may determine a “spearfishing” query based on the normalized user query, the customer purchase data associated with user queries within the experimental data, and a numerical threshold. For example, if the user query consists of “Samsung 16-inch OLED laptop” or “MX-1000a”, and the processor(s) determine, using the customer purchase data within the experimental data, that there a singular product purchased based on this specific user query, by a certain percentage of user (i.e. exceeding a specific numerical threshold, such as 90% of all users), then the processor(s) may determine that the type of the user query is a “spearfishing” query. In some embodiments, the processor(s) may store or update the user query type as a “spearfishing” type within the data structures/database.

In step 303, the one or more processors analyze the normalized user query and extracts at least one set of attributes and one pattern associated with the user query using at least one machine learning model. The machine learning model is based on at least one machine learning algorithm and the experimental data. The machine-learning algorithm may include, for example, Viterbi algorithms, Naïve Bayes algorithms, neural networks, etc. and/or joint dimensionality reduction techniques (e.g., cluster canonical correlation analysis, partial least squares, bilinear models, cross-modal factor analysis) configured to observe relationships between user query input data, and attributes and patterns associated with products based on the experimental data, validate the observations with product data and product category data within the experimental data set, and generate a set of attributes and at least one pattern associated with the product of interest according to the observations and validation by experimental data. The at least one machine-learning algorithm may be trained, for example, using a supervised learning method (e.g., gradient descent or stochastic gradient descent optimization methods). In some embodiments, one or more machine learning algorithms may be configured to generate an initial set of product query attributes, based on associations between classifications, that may be validated using custom knowledge. In some embodiments, the processor(s) update the relevant entries within the experimental data set and the product index data set which is associated with the product of interest with the set of attributes and at least one pattern determined by machine learning.

In step 303, the set of attributes associated with the queried product may include but is not limited to the product model number of the product which the user intends to search through the search query input (e.g. “RFA9285K1AP”). The set of attributes may also include but is not limited to a description of the product (e.g. “noise-cancelling headphones”) or a quantity (e.g. “4-pack ethernet cables”), or a product brand name (e.g. “Apple”, “Sony”) or any combination thereof. The at least one pattern based on the set of attributes may be a pattern that is associated with the user's product of interest based on the set of product attributes (e.g. “Sony noise-cancelling headphones MX-1000a”).

Process 300 then proceeds to step 304. In step 304, the one or more processors may determine at least one set of queried product or product category based on the attributes and at least one pattern of the queried product which the user intended to search for using at least one machine learning model and the experimental data. The machine learning model is based on at least one machine learning algorithm. The machine-learning algorithm may include, for example, Viterbi algorithms, Naïve Bayes algorithms, neural networks, etc. and/or joint dimensionality reduction techniques (e.g., cluster canonical correlation analysis, partial least squares, bilinear models, cross-modal factor analysis) configured to observe relationships between the attributes and patterns associated with the queried product and the hierarchical product categories based on the experimental data and generate a set of product categories associated with the intended product of purchase according to the observations. The at least one machine-learning algorithm may be trained, for example, using a supervised learning method (e.g., gradient descent or stochastic gradient descent optimization methods). In some embodiments, one or more machine learning algorithms may be configured to generate an initial set of product categories, based on associations between classifications, that may be validated using custom knowledge. For example, if the queried product is determined to be “Sony wireless headphones MX-1000”, then the set of queried product categories can include, but is limited to, “Electronics→Audio→Wireless Headphones.” In some embodiments, the one or more processors may determine a single queried product based on the spearfishing query.

Process 300 then proceeds to step 305. In step 305, the one or more processors may determine at least one target product which directly matches the queried product by performing an iterative string-matching between the product-number attribute associated with the queried product and data entries of product numbers within the product index data set (408 of FIG. 4). In some embodiments, the processor(s) may perform this direct matching based on the master list catalog of products obtained through external data mining (FIG. 4. 409). In some embodiments, the processor(s) may determine at least one target product matching a single queried product based on the spearfishing query.

Process 300 then proceeds to step 306 if no target product was identified after the iterative-matching process as described in 305. In step 306, the one or more processors determines at least one top alternative product associated with the user query.

In a deterministic approach 307, the processor(s) may determine the top alternative product based on a product category and/or a set of pre-defined rule set. For example, the processor(s) may determine that the queried product (e.g. “MX-1000a”) is within a certain product category (“laptop computers”), and apply a set of pre-defined rules to that specific product category to identify the top alternative product. In some embodiments, the processor(s) may determine a model reference group associated with the product model number of the queried product and apply a set of pre-defined rules. For example, the processor(s) may determine, for the product model number “MX-1000a”, that an associated model reference group is “MX.” In some embodiments, the processor(s) may determine at least one top alternative product based on the set of products matching the product category of the queried productassociated with and the pre-defined rule set. In some embodiments, the processor(s) may determine at least one top alternative product based on the set of products matching the model reference group associated with the queried product. In some embodiments, the processor(s) may determine that there is an insufficient number of top alternative products generated using the deterministic approach 307, and apply a pre-defined rule set to a set of product attributes (e.g. product year, screen size, etc) to determine additional top alternative products.

Alternatively, using a referential approach 307, the processor(s) may determine a plurality of key features associated with the queried product category based on the experimental data set. For example, the processor(s) may determine that the set of key features associated with the queried computer product “MX-1000a” could comprise “RAM”, “screen size”, “processor speed”, “weight”, etc. In some embodiments, the number of key features may be based on the product category, a static value, a static minimum value, or other attributes.

In some embodiments, the processor(s) may determine the set of key features associated with the queried product category based on matching product(s) within the master list catalog of products within the experimental data. In some embodiments, the processor(s) may determine the set of key features associated with the queried product category based on data obtained via data crawling or data mining from an external data source (e.g. a competitor's website). The processor(s) may determine at least one top alternative product using an iterative matching process based on a similarity metric between the set of key features associated with a candidate top alternative product and the set of key features associated with the queried product category, using machine learning algorithms. In some embodiments, the set of candidate top alternative products may comprise of products within the same product category as the queried product. The machine-learning algorithm may include, for example, Viterbi algorithms, Naïve Bayes algorithms, neural networks, etc. and/or joint dimensionality reduction techniques (e.g., cluster canonical correlation analysis, partial least squares, bilinear models, cross-modal factor analysis) configured to observe relationships between the set of key features associated with the queried product category and potential candidates for top alternative product within the database 407, based on the experimental data 409 and determine at least one top alternative product result according to the observations. The at least one machine-learning algorithm may be trained, for example, using a supervised learning method (e.g., gradient descent or stochastic gradient descent optimization methods). In some embodiments, one or more machine learning algorithms may be configured to generate an initial set of top alternative products, based on associations between classifications, that may be validated using custom knowledge. In some embodiments, the processor(s) may use a combination of the deterministic approach and the referential approach to determine at least one top alternative product. In some embodiments, the processor(s) may also determine the top alternative product based on a set of key features and a product category of a second product which has the highest search frequency by a subset of customers immediately prior to conducting the search for the queried product.

Process 300 then transmits the top alternative product results to the external front end system 103. The external front end system 103 may receive information for presentation and/or display of the top alternative product results to the user. The system 103 may present and/or display the top alternative products onto a webpage as in FIG. 1B or a display screen of the external device (e.g. mobile device 102A or computer 102B) for the user's perusal in order to complete the purchasing transaction. By presenting top alternative product results to the user in situations where no product was identified based on the product model number searched by the user, this system or method optimizes the user's purchase experience.

FIG. 4 is a diagrammatic illustration of an exemplary machine-learning-based system for identifying target products matching the user's queried product based on product model number and generating top alternative product search results. The user 401 initiates the product search process via inputting a search query (e.g. “RFA9285K1AP” or “Samsung 16-inch laptop”) into an external front end system 103 using a device such as a mobile phone or computer (e.g. mobile device 102A or computer 102B in FIG. 1a). One or more processors (processor 404) which may reside in system 100 retrieve the user's product query from the front end system 103 via an data I/O (“input/output”) module 405b. The one or more processors 404 may retrieve, from a database 407, a set of product index data 408 as well as a set of experimental data 409, which is transmitted to the processor via the data I/O module 406.

Based on the user query (e.g. “RFA9285K1AP”), the one or more processors performs standardization or normalization of the user query by applying natural language processing via the query analysis module 405c. The query analysis module 405c outputs a normalized user query (e.g. a query consisting of a non-standardized entry of a product model number “#RF-A-9285K1 AP!#” may become normalized as “RFA9285K1AP”).

The processor(s) 404 analyzes the normalized user query and determines at least one query type, which may consist of a “spearfishing” query type which consists of a search for a single product, or a query type which consist of a search for multiple products. In some embodiments, processor(s) 404 may determine a “spearfishing” search type based on the normalized user query, the customer purchase data associated with user queries within the experimental data set 409 which are stored in database 407, and a numerical threshold. For example, if the user query consists of “Samsung 16-inch OLED laptop” or “MX-2300A”, the processor(s) may determine, using the customer purchase data within the experimental data set 409, that there is a singular product purchased based on this specific user query, by a certain percentage of user (i.e. exceeding a specific numerical threshold, such as 90% of all users). The processor(s) may then determine that the type of the user query is a “spearfishing” query.

The processor(s) 404 may analyze the normalized user query and extract at least one set of attributes and one pattern associated with the user query by inputting the normalized user query into the machine learning module 405a, which may be configured to use at least one machine learning algorithm to observe relationships between the user query and product entries within the experimental data set 409 in database 407. In some embodiments, the machine learning module is configured to output at least one set of attributes and at least one pattern associated with the user query. In some embodiments, the processor(s) 404 update the relevant entries within the experimental data set 409 and the product index data set within database 407 with the set of attributes and at least one pattern determined by machine learning.

The processor(s) 404 may determine at least one set of queried product or product category by using machine learning module 405a wherein the attributes, the at least one pattern of the queried product, and the experimental data set 409 are used as input into the module 405a. The machine learning module 405a may be configured to use at least one machine learning algorithm to observe relationships between the attributes and patterns associated with the queried product and the hierarchical product categories based on the experimental data set 409 and generate a set of product categories associated with the intended product of purchase according to the observations. In some embodiments, the machine learning module 405a is configured to output at least one queried product or product category associated with the user query. In some embodiments, the processor(s) 404 update the relevant entries within the experimental data set 409 and the product index data set within database 407 with the queried product category associated with the queried product as determined by machine learning.

The processor(s) 404 may determine at least one target product which directly matches the queried product by performing an iterative string-matching between the product-number attribute associated with the queried product and data entries of product numbers within the product index data set (408). In some embodiments, the product index data set may consist of linear data structures including but not limited to tables, arrays, linked lists, or non-linear data structures including but not limited to graph data structures or tree data structures. In some embodiments, database 407 may consists of but is not limited to MySQL databases or NoSQL databases such as Cassandra.

The one or more processors may determine a top alternative product based on a deterministic approach based on the product category and a predefined rule set stored with database 407. In some embodiments, the predefined rule set may be stored in linear data structures including but not limited to tables, arrays, linked lists, or non-linear data structures including but not limited to graph data structures or tree data structures. In some embodiments, processor(s) 404 retrieves the predefined rule set from database 407 and apply the rule set to that specific product category to identify the top alternative product. In some embodiments, the processor(s) 404 may determine a model group associated with the product model number by applying the predefined rule set to the queried product category. In some embodiments, the processor(s) 404 may determine at least one top alternative product based on the set of all products within the same model group and the pre-defined rule set. The processor(s) 404 may transmit the model group associated with the product model number to database 407 via data I/O module 405b for storage within the product index data set 408.

Alternatively, the one or more processors 404 may also determine top alternative product results based on a referential approach by, using machine learning module 405, determining a set of key attributes associated with the product category based on the experimental data set 409, and determining top alternative products based on the key attributes and the product category. In some embodiments, experimental data set 409 may consists of but is not limited to a set of historical customer purchase data 409a aggregated across all users or a subset of all users over a predefined time frame. In some embodiments, experimental data set 409 may consists of but is not limited to a master list catalog of products 409b based on data crawling or data mining from an external data source (e.g. a competitor's product website).

In at least some embodiments, the processor(s) 404 may determine the set of key features associated with the queried product category based on matching product(s) within the master list catalog of products within the experimental data 409. In some embodiments, the processor(s) may determine the set of key features associated with the queried product category based on data obtained via data crawling or data mining from an external data source (e.g. a competitor's website). The processor(s) 404 may determine at least one top alternative product using an iterative matching process based on a similarity metric between the set of key features associated with a candidate top alternative product and the set of key features associated with the queried product category, using machine learning algorithms. In some embodiments, the set of candidate top alternative products may comprise of the set of products within the same product category as the queried product stored in the product index data set 408 in database 407, or the set of products within the master list catalog of products stored in the experimental data set 409 in database 407.

The processor(s) 404 may present the target product or the top alternative product results to the user by transmitting the product search results via the Data I/O module 405b to the external front end system 103 (e.g. mobile device 102A or computer 102B as in FIG. 1a).

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system for identifying a target product and generating alternative product recommendations based on a user query, the system comprising:
a memory storing instructions; and
at least one processor configured to execute the instructions to perform operations comprising:
retrieving, from one or more data structures:
a product search query by the user,
at least one data set, and
a set of experimental data;
determining, using at least one machine-learning algorithm:
a search type,
a plurality of attributes associated with the product search query, and
at least one pattern associated with the plurality of attributes;
determining at least one queried product and at least one queried product category associated with the product search query
based on the plurality of attributes, the at least one pattern,
the search type, and the dataset;
determining a target product based on the queried product;
determining a plurality of key features associated with the queried product category based on the experimental data;
determining, using at least one machine-learning algorithm, at least one top alternative product based on the plurality of key features or the queried product category;
transmitting the target product and the top alternative product for display to the user.

2. The system of claim 1, wherein the at least one data set comprises a catalogue of product model numbers collected over a predefined time frame.

3. The system of claim 1, wherein the user product search query comprises at least an alphanumeric product model number, a text string, or a combination thereof.

4. The system of claim 1, wherein the experimental data comprises at least aggregated purchase data from all customers or a subset of all customers.

5. The system of claim 1, wherein the data structures comprise linear data structures, or non-linear data structures.

6. The system of claim 1, wherein the plurality of attributes associated with the product query comprises a product model number, a product name, or product description.

7. The system of claim 1, wherein the determination of the key features associated with the queried product is further based on mined data from at least one external data source.

8. The system of claim 1, wherein the determination of the top alternative product is based on the queried product category and an associated set of pre-determined rules.

9. The system of claim 1, wherein the determination of the top alternative product is based on an inference relating to the plurality of key features associated with the product.

10. The system of claim 1, wherein the determination of the top alternative product is based on key features and product category of a second product which has the highest search frequency by customers immediately prior to the search of the queried product.

11. A computer-implemented method for identifying a target product and generating alternative product recommendations based on a user query, the method comprising:
retrieving, from one or more data structures:
a product search query by the user,
at least one data set, and
a set of experimental data;
determining, using at least one machine-learning algorithm:
a search type,
a plurality of attributes associated with the product search query, and
at least one pattern associated with the plurality of attributes;
determining at least one queried product and at least one queried product category associated with the product search query
based on the plurality of attributes, the at least one pattern, the search type, and the dataset;
determining a target product based on the queried product;
determining a plurality of key features associated with the queried product category based on the experimental data;
determining, using at least one machine-learning algorithm, at least one top alternative product based on the plurality of key features or the queried product category;
transmitting the target product and the top alternative product for display to the user.

12. The method of claim 10, wherein the at least one data set comprises a catalogue of product model numbers collected over a predefined time frame.

13. The method of claim 10, wherein the experimental data comprises at least aggregated purchase data from all customers or a subset of all customers.

14. The method of claim 10, wherein the data structures comprise linear data structures or non-linear data structures.

15. The method of claim 10, wherein the plurality of attributes associated with the product query comprises a product model number, a product name, or product description.

16. The system of claim 10, wherein the determination of the key features associated with the queried product is further based on the mined data from at least one external data source.

17. The method of claim 10, wherein the determination of the top alternative product is based on the queried product category.

18. The method of claim 10, wherein the determination of the top alternative product is based on the plurality of key features associated with the product.

19. The method of claim 10, wherein the determination of the top alternative product is based on key features and product category of a second product which has the highest search frequency by customers immediately prior to the search of the queried product.

20. A computer-implemented system for identifying a target product and generating alternative product recommendations based on a user query, the system comprising:
a memory storing instructions; and
at least one processor configured to execute the instructions to perform operations comprising:
retrieving, from one or more data structures:
a product search query by the user comprising at least an alphanumeric product model number, a text string, or any combination thereof,
at least one data set comprising at least a catalogue of product model numbers collected over a predefined time frame, and
a set of experimental data comprising at least aggregated customer data from all customers or a subset of all customers;
determining, using at least one machine-learning algorithm:
a search type,
a plurality of attributes associated with the product query comprising at least a product model number, a product name, or product description, and
at least one pattern associated with the plurality of attributes;
determining at least one queried product and at least one queried product category associated with the product search query
based on the plurality of attributes, the at least one pattern, the search type, and the dataset;
determining a target product based on the queried product;
determining a plurality of key features associated with the queried product category based on the experimental data and mined data from at least one external data source;
determining, using at least one machine-learning algorithm, at least one top alternative product based on the application of a pre-determined ruleset to the queried product category or an inference which is based on the plurality of key features associated with the product.
transmitting the target product and the top alternative product for display on an external device to the user.
